(19) United States
(12) Patent Application Publication
(10) Pub. No.: US 2010/0129624 A1
(43) Pub. Date: May 27, 2010

(54) MULTI-LAYER FILM STRUCTURE WITH MEDIUM LAYER

(75) Inventors: GA-LANE CHEN, Santa Clara, CA (US); CHAO-TSANG WEI, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/543,601

(22) Filed: Aug. 19, 2009

(30) Foreign Application Priority Data
Nov. 21, 2008 (CN) 200810305689.3

(51) Int. Cl. B32B 33/00; B32B 15/04; B32B 7/02

(52) U.S. Cl. 428/213; 428/448; 428/696; 428/702; 428/472; 428/457; 428/336; 428/426

(57) ABSTRACT

An exemplary multi-layer film structure includes a substrate, an inmost layer clinging to the substrate, a medium layer, and a reflective-transmissive layer. The medium layer is formed on the clinging layer. The reflective-transmissive layer is formed on the medium layer. The reflective-transmissive layer is capable of reflecting a portion of incident light to be a first reflected light and allowing another portion of the incident light to transmit therethrough. The substrate is capable of reflecting the transmitted light to be a second reflected light. The medium layer is configured for controlling a light path difference between the first reflected light and the second reflected light thereby allowing the second reflected light to interfere with the first reflected light and provide the multi-layer film structure with a desired color appearance.

### CROSS-REFERENCE TO RELATED APPLICATIONS

This application is related to commonly-assigned co-pending applications entitled, “MULTI-LAYER FILM AND ELECTRONIC DEVICE SHELL HAVING SAME,” (Atty. Docket No. US24658), and “MULTI-LAYER FILM AND ELECTRONIC DEVICE SHELL WITH SAME,” (Atty. Docket No. US24274). The above-identified applications are filed simultaneously with the present application. The disclosures of the above identified applications are incorporated herein by reference.

### BACKGROUND

1. Technical Field

The present disclosure relates to multi-layer film structures, and particularly, to a colored multi-layer film structure.

2. Description of Related Art

Colored layer structures are used on shells of electronic devices such as mobile phones. Currently, the coloration of such shells is usually produced by painting. However, many paints are not environmentally friendly. For example, some paints or by-products thereof can be harmful to humans. Furthermore, many painted surfaces are not wear-resistant and are easily scratched.

What is needed, therefore, is a film structure which can overcome the above shortcomings.

### BRIEF DESCRIPTION OF THE DRAWINGS

Many aspects of the present multi-layer film structure can be better understood with reference to the following drawings. The components in the drawings are not necessarily drawn to scale, the emphasis instead being placed upon clearly illustrating the principles of the present multi-layer film structure. Moreover, in the drawings, all the views are schematic, and like reference numerals designate corresponding parts throughout the views.

FIG. 1 is a cross-sectional view of a multi-layer film structure in accordance with a first embodiment.

FIG. 2 is a cross-sectional view of a multi-layer film structure in accordance with a second embodiment.

FIG. 3 is a cross-sectional view of a shell of an electronic device in accordance with a third embodiment, the shell being an application environment of a multi-layer film structure.

### DETAILED DESCRIPTION OF EMBODIMENTS

Various embodiments of the present multi-layer film structure will now be described in detail below and with reference to the drawings.

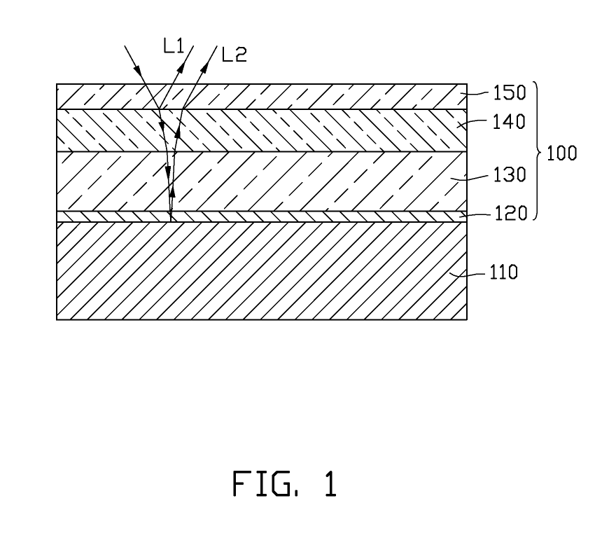

Referring to FIG. 1, an exemplary multi-layer film structure in accordance with a first embodiment is shown. The multi-layer film structure includes a multi-layer film 100 and a substrate 110. The multi-layer film 100 includes in sequence an inmost layer 120, a medium layer 130, a reflective-transmissive layer 140 and an outmost layer 150.

The inmost layer 120 is configured (i.e. structured and/or arranged) to cling (adhere) to the substrate 110. The substrate 110 can be made of glass, plastic, metal, or ceramic. The substrate 110 can have a wide range of thicknesses, depending on the particular application. For example, the thickness may be in a range of from two microns to more than two centimeters. The inmost layer 120 is metallic, and a thickness thereof is in a range of from 0.3 nanometers (nm) to 10 nm. In the present embodiment, the inmost layer 120 contains chromium, and a thickness of the inmost layer 120 is approximately 0.5 nm. Because the thickness of the inmost layer 120 is slight, little light is reflected by the inmost layer 120.

The medium layer 130 is adjacent to the inmost layer 120. The medium layer can be formed on the inmost layer 120 by sputtering or chemical vapor deposition. The medium layer 130 is transparent, and contains a material selected from a group consisting of silicon dioxide, titanium oxide, niobium oxide, aluminum oxide and magnesium fluoride. In the present embodiment, the medium layer 130 contains silicon dioxide. A thickness of the medium layer 130 can be in a range of from 50 nm to 1000 nm; for example, 131 nm, 188 nm, 206 nm, 431 nm or 518 nm. The medium layer 130 is capable of controlling a color appearance of the entire multi-layer film 100, by way of variation of the thickness of the medium layer 130. The principle is explained below.

The reflective-transmissive layer 140 is formed on the medium layer 130. The reflective-transmissive layer 140 is metallic. In the present embodiment, the reflective-transmissive layer 140 contains aluminum, and the reflective-transmissive layer 140 can be formed on the medium layer 130 by evaporation. A thickness of the reflective-transmissive layer 140 can be in a range of from 20 nm to 200 nm. The reflective-transmissive layer 140 reflects a portion of incident light, and allows another portion of the incident light to transmit therethrough. The portion of incident light reflected is designated as a first reflected light L1, and may for example be visible light which includes red, orange, yellow, green, blue, indigo and violet lightwaves.

The outmost layer 150 is formed on the reflective-transmissive layer 140. The outmost layer 150 is metallic, and thus is wear-resistant. Depending on the type of metal used, the outmost layer 150 may also be corrosion-resistant. In the present embodiment, the outmost layer 150 contains chromium, and the outmost layer 150 can be formed on the reflective-transmissive layer 140 by liquid phase deposition or physical vapor deposition. A thickness of the outmost layer 150 can be in a range of from 1 nm to 30 nm. Because the thickness is slight, little light is reflected by the outmost layer 150.

The substrate 110 has a thickness greater than that of the entire multi-layer film 100. Accordingly, light transmitted through the multi-layer film 100 can be reflected by the substrate 110. Such reflected light is designated as a second reflected light L2. The medium layer 130 is located between the substrate 110 and the reflective-transmissive layer 140, and thus is capable of controlling a difference between the light path of the first reflected light L1 and the light path of the second reflected light L2. Thereby, the second reflected light L2 can interfere with the first reflected light L1 in a desired manner.

When the light path difference between the first reflected light L1 and the second reflected light L2 is an even multiple of half of a central wavelength of a particular color lightwave of the visible light, that color lightwave is enhanced. Under this condition, the multi-layer film 100 (and also the entire multi-layer film structure) would appear to have a color substantially that of the most enhanced color lightwave. In one example, among the color lightwaves of visible light, i.e., red, orange, yellow, green, blue, indigo and violet, two of these color lightwaves may be enhanced. For instance, red and green lightwaves may both be enhanced. In such example, the multi-layer film 100 would appear to have a color comprised of a mixture of red and green; i.e., yellow. If the red lightwaves are enhanced more than the green lightwaves, the color has a tinge of red in it. If the green lightwaves are enhanced more than the red lightwaves, the color has a tinge of green in it.

Other more particular examples are as follows. When the thickness of the medium layer 130 is in a range of from 121 nm to 141 nm, for example, 131 nm, the color appearance of the multi-layer 100 is substantially blue. When the thickness of the medium layer 130 is in a range of from 177 nm to 195 nm, for example, 188 nm, the color appearance of the multi-layer 100 is substantially yellow. When the thickness of the medium layer 130 is in a range of from 196 nm to 226 nm, for example, 206 nm, the color appearance of the multi-layer 100 is substantially orange. When the thickness of the medium layer 130 is in a range of from 421 nm to 441 nm, for example, 431 nm, the color appearance of the multi-layer 100 is substantially violet (or violet). When the thickness of the medium layer 130 is in a range of from 514 nm to 534 nm, for example, 518 nm, the color appearance of the multi-layer 100 is substantially green.

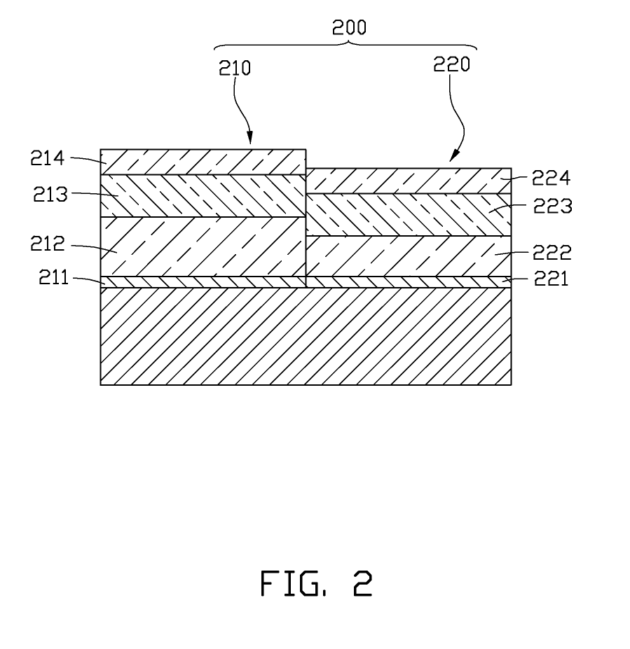

Referring to FIG. 2, an exemplary multi-layer film structure in accordance with a second embodiment is shown. The multi-layer film structure is essentially similar to the multi-layer film structure described above. However, the multi-layer film 200 includes a first colored portion 210 and a second colored portion 220. The first colored portion 210 includes in sequence an inmost layer 211, a medium layer 212, a reflective-transmissive layer 213 and an outmost layer 214. The second colored portion 220 includes in sequence an inmost layer 221, a medium layer 222, a reflective-transmissive layer 223 and an outmost layer 224. In the present embodiment, substantially the only difference between the layers 211, 212, 213, 214 of the first colored portion 210 and the layers 221, 222, 223, 224 of the second colored portion 220 is that the thickness of the medium layer 212 is different from that of the medium layer 222. With this configuration, the color appearance of the first colored portion 210 is different from the color appearance of the second colored portion 220. In alternative embodiments, the inmost layers 211 and 221 can instead be the one same continuous single inmost layer.

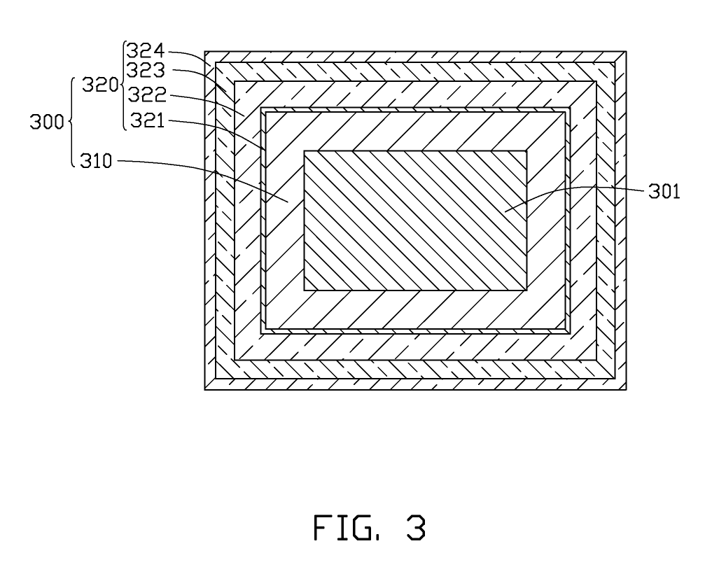

Referring to FIG. 3, a shell 300 of an electric device 301 is provided as an exemplary embodiment of an application environment of a multi-layer film structure. The shell 300 includes an enclosure preform 310 configured as a substrate, and a multi-layer film 320 formed on the enclosure preform 310. In the illustrated embodiment, the multi-layer film 320 is essentially similar to the multi-layer film 100 described above. That is, the multi-layer film 320 includes in sequence an inmost layer 321, a medium layer 332, a reflective-transmissive layer 323 and an outmost layer 324.

It is understood that the above-described embodiments are intended to illustrate rather than limit the disclosure. Variations may be made to the embodiments without departing from the spirit of the disclosure. Accordingly, it is appropriate that the appended claims be construed broadly and in a manner consistent with the scope of the disclosure.

What is claimed is:

1. A multi-layer film structure, comprising:
a substrate;
an inmost layer clinging to the substrate;
a transparent medium layer formed on the inmost layer, the medium layer comprising a material selected from the group consisting of silicon dioxide, titanium oxide, niobium oxide, aluminum oxide and magnesium fluoride; and
a reflective-transmissive layer formed on the transparent medium layer, wherein the reflective-transmissive layer is capable of reflecting a portion of incident light received from an outside of the multi-layer film structure to be a first reflected light and allowing another portion of the incident light to transmit therethrough, the substrate is capable of reflecting the light transmitted by the reflective-transmissive layer to be a second reflected light, and the medium layer is configured for controlling a light path difference between the first reflected light and the second reflected light thereby allowing the second reflected light to interfere with the first reflected light and provide the multi-layer film structure with a desired color appearance.

2. The multi-layer film structure as described in claim 1, wherein the inmost layer is metallic.

3. The multi-layer film structure as described in claim 2, wherein the inmost layer comprises chromium.

4. The multi-layer film structure as described in claim 1, wherein the reflective-transmissive layer comprises aluminum.

5. The multi-layer film structure as described in claim 1, further comprising a metallic outmost layer formed on the reflective-transmissive layer.

6. The multi-layer film structure as described in claim 5, wherein the outmost layer comprises chromium.

7. The multi-layer film structure as described in claim 5, wherein a thickness of the inmost layer is in a range of from 0.3 nm to 10 nm, a thickness of the reflective-transmissive layer is in a range of from 20 nm to 200 nm, and a thickness of the outmost layer is in a range of from 1 nm to 30 nm.

8. The multi-layer film structure as described in claim 1, wherein a thickness of the medium layer is in a range of from 121 nm to 141 nm, and the color appearance of the multi-layer film structure is substantially blue.

9. The multi-layer film structure as described in claim 1, wherein a thickness of the medium layer is in a range of from 177 nm to 195 nm, and the color appearance of the multi-layer film structure is substantially yellow.

10. The multi-layer film structure as described in claim 1, wherein a thickness of the medium layer is in a range of from 196 nm to 226 nm, and the color appearance of the multi-layer film structure is substantially orange.

11. The multi-layer film structure as described in claim 1, wherein a thickness of the medium layer is in a range of from 421 nm to 441 nm, and the color appearance of the multi-layer film structure is substantially violet.

12. The multi-layer film structure as described in claim 1, wherein a thickness of the medium layer is in a range of from 514 nm to 534 nm, and the color appearance of the multi-layer film structure is substantially green.

13. The multi-layer film structure as described in claim 1, wherein the substrate comprises the material selected from the group consisting of glass, plastic, metal and ceramic.

14. The multi-layer film structure as described in claim 5, wherein each of the transparent medium layer, the metallic reflective-transmissive layer and the metallic outmost layer comprises a first portion and a second portion, and a thickness of the first portion of the medium layer is different from that of the second portion of the medium layer, thereby providing a corresponding first portion of the multi-layer film structure with a first desired color appearance and a corresponding second portion of the multi-layer film structure with a second desired color appearance different from the first desired color appearance.

15. A multi-layer film structure, comprising:
a substrate;
an inmost layer adhering to the substrate;
a transparent medium layer formed on the clinging layer, the medium layer comprising silicon dioxide; and
a metallic reflective-transmissive layer formed on the medium layer, wherein the metallic reflective-transmissive layer is capable of reflecting a portion of incident ambient light to be a first reflected light and transmitting another portion of the incident ambient light therethrough, the substrate is capable of reflecting the transmitted light to be a second reflected light, and a thickness of the medium layer is configured for controlling a light path difference between the first reflected light and the second reflected light such that the second reflected light interferes with the first reflected light and gives the multi-layer film structure a predetermined color appearance.

16. The multi-layer film structure as described in claim 15, wherein the substrate is an enclosure of an electronic device.

17. The multi-layer film structure as described in claim 15, further comprising a metallic outmost layer formed on the metallic reflective-transmissive layer.

18. The multi-layer film structure as described in claim 17, wherein each of the transparent medium layer, the metallic reflective-transmissive layer and the metallic outmost layer comprises a first portion and a second portion, and a thickness of the first portion of the transparent medium layer is different from that of the second portion of the transparent medium layer, thereby giving a corresponding first portion of the multi-layer film structure a first predetermined color appearance and a corresponding second portion of the multi-layer film structure a second predetermined color appearance different from the first predetermined color appearance.
